(19) United States
(12) Patent Application Publication
(10) Pub. No.: US 2016/0348639 A1
(43) Pub. Date: Dec. 1, 2016

(54) Compact air or water turbine actuated generator having an air tunneling feature for use on a land or water based vehicle

(71) Applicant: Daniel Beauchamp, Gatineau (CA)

(72) Inventor: Daniel Beauchamp, Gatineau (CA)

(21) Appl. No.: 15/158,722

(22) Filed: May 19, 2016

(30) Foreign Application Priority Data
May 27, 2015 (GB) 1509091.3

(51) Int. Cl. F03B 13/10; F03D 1/04; H02K 7/18; F01D 15/10; F03B 11/02; F03D 9/00

(52) U.S. Cl. CPC F03B 13/105; F03B 11/02; F03D 9/002; H02K 7/1823; F01D 15/10; F03D 1/04

(57) ABSTRACT

An air or water turbine actuated generator having an air funneling feature. comprises one or more funnels concentrating a flow of air or water onto a turbine connected to a generator and related power converter and battery. The invention comes in different configurations and can form part of various land, water, or air borne vehicles.

### FIELD OF THE INVENTION

The present invention relates generally to energy generation but more particularly to an air or water turbine actuated generator having an air funneling feature.

### BACKGROUND OF THE INVENTION

Harnessing the power of air or water has been known for thousands of years and is still a viable form of energy generation. There is always room for improvement in that field.

### SUMMARY OF THE INVENTION

The purpose of this invention is to provide for an air or water turbine generator having an air funneling feature that is small enough to be fitted on a vehicle.

In order to do so, the invention comprises one or more funnels concentrating a flow of air or water onto a turbine connected to a generator and related power converter and battery. The invention comes in different configurations and can form part of various land, water, or air borne vehicles.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Plan schematic view of the invention.

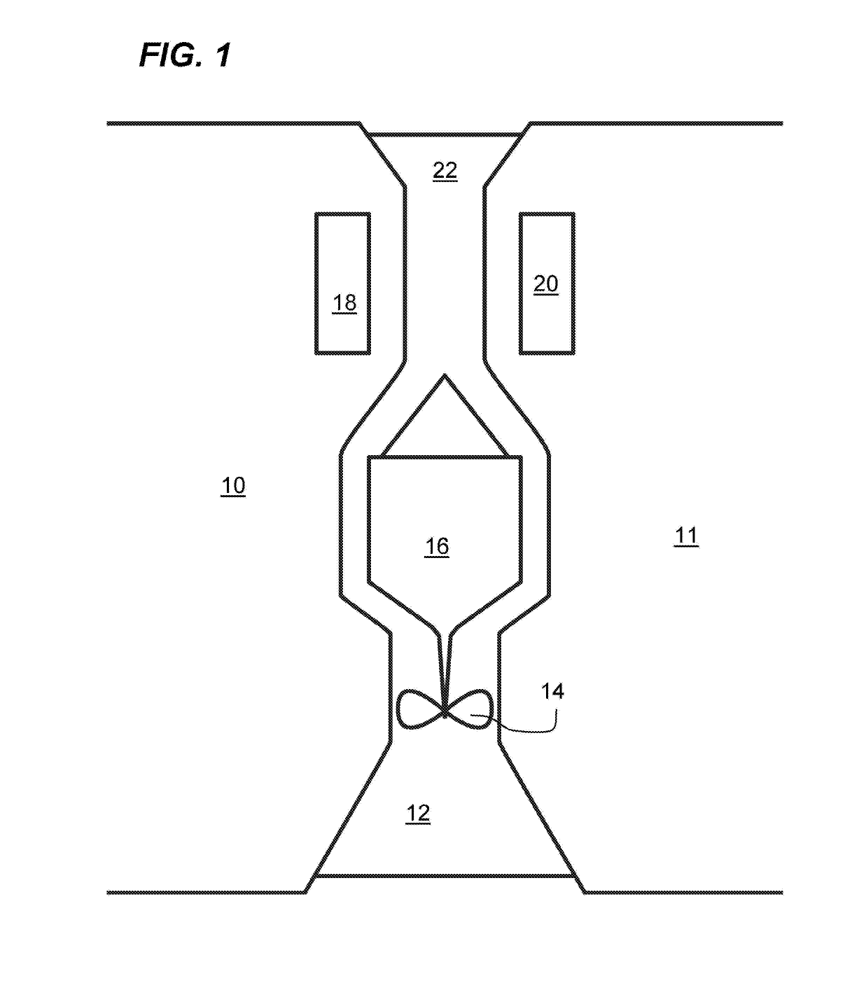

FIG. 2 Front see through view of the invention.

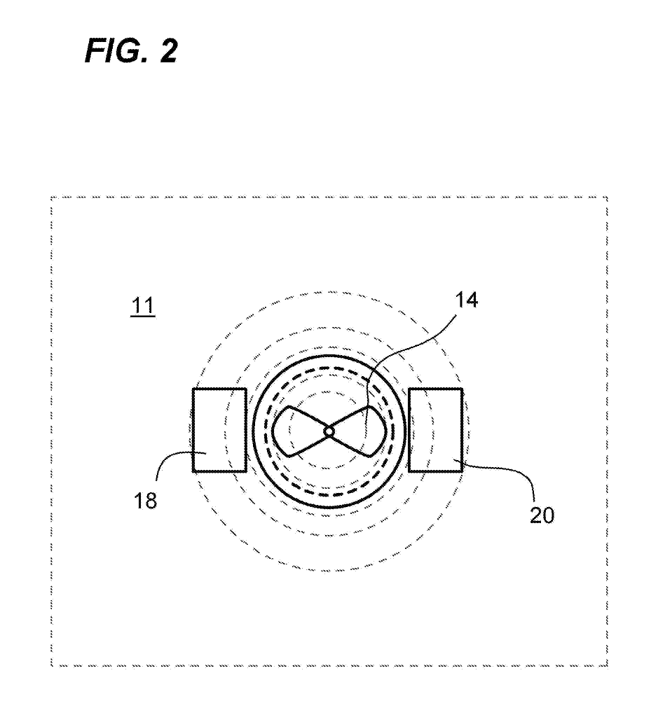

### DETAILED DESCRIPTION

An air or water turbine generator (10) has a casing (11) comprised of at least one funnel member (12) concentrating a flow of fluid (air or water) onto a turbine member (14) connected to a generator member (16), an inverter apparatus (18), and at least one battery (20). At least one exit port (22) allows for the fluid to exit.

When forming part of a land based vehicle, the forward motion of the vehicle forces air into the funnel member (12), thus producing some electricity which can be used for various purposes.

When forming part of a water based vehicle, the forward motion of the vehicle forces water into the funnel member (12), thus producing some electricity which can be used for various purposes.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An air or water turbine generator has a casing comprised of at least one funnel member concentrating a flow of fluid onto a turbine member connected to a generator member, an inverter apparatus, and at least one battery; at least one exit port allows for the fluid to exit.

2. A combination of a land based vehicle and an air turbine generator is comprised of a casing comprised of at least one funnel member concentrating a flow of air onto a turbine member connected to a generator member, an inverter apparatus, and at least one battery; at least one exit port allows for the fluid to exit.

3. A combination of a water based vehicle and an air turbine generator is comprised of a casing comprised of at least one funnel member concentrating a flow of water onto a turbine member connected to a generator member, an inverter apparatus, and at least one battery; at least one exit port allows for the fluid to exit.
